(19) United States
(12) Patent Application Publication
(10) Pub. No.: US 2022/0315480 A1
(43) Pub. Date: Oct. 6, 2022

(54) POROUS GLASS MEMBER PRODUCTION METHOD

(71) Applicant: NIPPON ELECTRIC GLASS CO., LTD., Otsu-shi, Shiga (JP)

(72) Inventor: Takashi AITOKU, Otsu-shi (JP)

(21) Appl. No.: 17/642,254

(22) PCT Filed: Oct. 29, 2020
(86) PCT No.: PCT/JP2020/040620

§ 371 Date: Mar. 11, 2022

(30) Foreign Application Priority Data
Nov. 11, 2019 (JP) 2019-203902

(51) Int. Cl. C03C 11/00; C03C 3/097; C03C 3/093; C03C 3/089; C03C 15/00; C03B 32/00

(52) U.S. Cl. CPC C03C 11/005; C03C 3/097; C03C 3/093; C03C 3/089; C03C 15/00; C03B 32/00

(57) ABSTRACT

Provided is a method for producing a porous glass member whereby cracking during production is less likely to occur and a porous glass member having excellent alkali resistance can be produced. A method for producing a porous glass member includes the steps of: subjecting a glass base material containing, in terms of % by mole, 40 to 80% SiO₂, over 0 to 40% B₂O₃, 0 to 20% Li₂O, 0 to 20% Na₂O, 0 to 20% K₂O, over 0 to 2% P₂O₅, over 0 to 20% ZrO₂, 0 to 10% Al₂O₃, and 0 to 20% RO (where R represents at least one selected from among Mg, Ca, Sr, and Ba) to thermal treatment to separate the glass base material into two phases; and removing one of the two phases with an acid.

### TECHNICAL FIELD

The present invention relates to methods for producing a porous glass member.

### BACKGROUND ART

Porous glass has a sharp pore distribution and a large specific surface area and also has thermal resistance and organic solvent resistance and, therefore, its use in a wide range of applications, including a separation membrane, a diffuser tube, an electrode material, and a catalyst support, is recently under consideration. Generally, porous glass is produced by thermally treating a glass base material made of alkali borosilicate glass to separate it into two phases: a silica-rich phase and a boron oxide-rich phase and removing the boron oxide-rich phase with an acid (see, for example, Patent Literature 1).

### CITATION LIST

### Patent Literature

### [PTL 1]

JP-A-S48-101409

### SUMMARY OF INVENTION

### Technical Problem

The above-described applications of porous glass include use in an alkaline environment. In consideration of the application to such use, porous glass needs to have alkali resistance. However, conventional porous glasses have a problem of poor alkali resistance.

In view of the above, the present invention has an object of providing a method for producing a porous glass member whereby a porous glass member having excellent alkali resistance can be produced.

### Solution to Problem

The inventor conducted intensive studies and, as a result, found that the above technical problem can be solved by strictly restricting the composition of a base material for a porous glass member.

Specifically, a method for producing a porous glass member according to the present invention includes the steps of: subjecting a glass base material containing, in terms of % by mole, 40 to 80% SiO₂, over 0 to 40% B₂O₃, 0 to 20% Li₂O, 0 to 20% Na₂O, 0 to 20% K₂O, over 0 to 2% P₂O₅, over 0 to 20% ZrO₂, 0 to 10% Al₂O₃, and 0 to 20% RO (where R represents at least one selected from among Mg, Ca, Sr, and Ba) to thermal treatment to separate the glass base material into two phases; and removing one of the two phases with an acid.

Herein, “x+y+ . . . ” means the total content of x, y, . . . which are components. Furthermore, “x/y” means a value obtained by dividing the content of x by the content of y.

In the method for producing a porous glass member according to the present invention, the glass base material preferably has an aspect ratio of 2 to 1000. The aspect ratio can be calculated by the following equation.

Aspect ratio=(base area of the glass base material)^{1/2}/(thickness of the glass base material)

In the method for producing a porous glass member according to the present invention, a temperature for the thermal treatment is preferably 500 to 800° C.

A glass base material for a porous glass member according to the present invention contains, in terms of % by mole, 40 to 80% SiO₂, over 0 to 40% B₂O₃, 0 to 20% Li₂O, 0 to 20% Na₂O, 0 to 20% K₂O, over 0 to 2% P₂O₅, over 0 to 20% ZrO₂, 0 to 10% Al₂O₃, and 0 to 20% RO (where R represents at least one selected from among Mg, Ca, Sr, and Ba).

A porous glass member according to the present invention contains, in terms of % by mass, 50 to 99% SiO₂, 0 to 15% Na₂O, 0 to 10% K₂O, over 0 to 10% P₂O₅, over 0 to 30% ZrO₂, over 0 to 20% Al₂O₃, and 0 to 20% RO (where R represents at least one selected from among Mg, Ca, Sr, and Ba).

### Advantageous Effects of Invention

The present invention enables provision of a method for producing a porous glass member whereby a porous glass member having excellent alkali resistance can be produced.

### DESCRIPTION OF EMBODIMENTS

A method for producing a porous glass member according to the present invention includes the steps of: subjecting a glass base material containing, in terms of % by mole, 40 to 80% SiO₂, over 0 to 40% B₂O₃, 0 to 20% Li₂O, 0 to 20% Na₂O, 0 to 20% K₂O, over 0 to 2% P₂O₅, over 0 to 20% ZrO₂, 0 to 10% Al₂O₃, and 0 to 20% RO (where R represents at least one selected from among Mg, Ca, Sr, and Ba) to thermal treatment to separate the glass base material into two phases; and removing one of the two phases with an acid.

The following description is given of the reasons why the content of each component of the glass base material is specified as above. In the following description of the respective contents of components, % refers to “% by mole” unless otherwise specified.

SiO₂ is a component that forms a glass network. The content of SiO₂ is 40 to 80%, preferably 45 to 75%, more preferably 47 to 65%, and particularly preferably 50 to 60%. If the content of SiO₂ is too small, the weather resistance and mechanical strength of the porous glass member tend to decrease.

Additionally, in the production process, the amount of expansion due to hydration of silica gel is likely to be smaller than the amount of contraction due to elution of alkaline components, such as Na₂O, from a silica-rich phase, which makes it likely that the porous glass member cracks. On the other hand, if the content of SiO₂ is too large, phase separation is less likely to occur.

B₂O₃ is a component that forms a glass network and promotes phase separation. The content of B₂O₃ is over 0 to 40%, preferably 10 to 30%, and particularly preferably 15 to 25%. If the content of B₂O₃ is too large, the weather resistance of the glass base material is likely to decrease.

Li₂O is a component that decreases the melting temperature to improve meltability and also a component that promotes phase separation. The content of Li₂O is 0 to 20%, preferably over 0 to 20%, more preferably over 0 to 15%, still more preferably 0.3 to 15%, yet still more preferably 0.3 to 10%, and particularly preferably 0.6 to 10%. If the content of Li₂O is too large, phase separation is less likely to occur contrariwise.

Na₂O is a component that decreases the melting temperature to improve meltability and also a component that promotes phase separation. The content of Na₂O is 0 to 20%, preferably over 0 to 20%, more preferably 3 to 15%, and particularly preferably 4 to 10%. If the content of Na₂O is too small, the above effects are difficult to achieve. On the other hand, if the content of Na₂O is too large, phase separation is less likely to occur contrariwise.

K₂O is a component that decreases the melting temperature to improve meltability and also a component that promotes phase separation. K₂O is also a component that increases the content of ZrO₂ in a silica-rich phase. Therefore, by containing K₂O in the glass base material, the content of ZrO₂ in the obtained porous glass member increases, so that the alkali resistance can be increased. The content of K₂O is 0 to 20%, preferably over 0 to 20%, more preferably 0.3 to 5%, still more preferably 0.5 to 3%, and particularly preferably 0.8 to 3%. If the content of K₂O is too large, phase separation is less likely to occur contrariwise.

The content of Li₂O+Na₂O+K₂O is 0 to 20%, preferably over 0 to 20%, more preferably 2 to 15%, still more preferably 4 to 12%, and particularly preferably 5 to 10%. If the content of Li₂O+Na₂O+K₂O is too large, phase separation is less likely to occur.

The ratio Na₂O/B₂O₃ is preferably 0.1 to 0.5, more preferably 0.15 to 0.45, and particularly preferably 0.2 to 0.4. Thus, in the production process, a balance is achieved between the amount of expansion due to hydration of silica gel and the amount of contraction due to elution of Na₂O from a silica-rich phase, which makes it less likely that the porous glass member cracks.

The ratio (Li₂O+Na₂O+K₂O)/B₂O₃ is preferably 0.2 to 0.5, more preferably 0.29 to 0.45, still more preferably 0.31 to 0.42, and particularly preferably 0.33 to 0.42. Thus, in the production process, a balance is achieved between the amount of expansion due to hydration of silica gel and the amount of contraction due to elution of alkaline components from a silica-rich phase, which makes it less likely that the porous glass member cracks.

P₂O₅ is a component that significantly promotes phase separation. P₂O₅ is also a component that increases the content of ZrO₂ in a silica-rich phase. Therefore, by containing P₂O₅ in the glass base material, the content of ZrO₂ in the obtained porous glass member increases, so that the alkali resistance can be increased. The content of P₂O₅ is over 0 to 2%, preferably 0.01 to 1.5%, and particularly preferably 0.02 to 1%. If the content of P₂O₅ is too small, the above effects are difficult to achieve. On the other hand, if the content of P₂O₅ is too large, phase separation is likely to occur during melting. If the glass causes phase separation during melting, the condition of phase separation cannot be controlled, which makes it difficult to obtain a transparent glass. In addition, if the content of P₂O₅ is too large, the glass is likely to crystallize during melting, in which case also a transparent glass is difficult to obtain.

ZrO₂ is a component that increases the weather resistance of the glass base material and the alkali resistance of the porous glass member. The content of ZrO₂ is over 0 to 20%, preferably 2 to 15%, and particularly preferably 2.5 to 12%. If the content of ZrO₂ is too small, the above effects are difficult to achieve. On the other hand, if the content of ZrO₂ is too large, devitrification is likely to occur and phase separation is less likely to occur.

The ratio P₂O₅/ZrO₂ is preferably 0.005 to 0.5 and particularly preferably 0.01 to 0.2. If the ratio P₂O₅/ZrO₂ is too large, the glass is likely to cause phase separation or crystallization during melting, which makes it difficult to obtain a transparent glass. On the other hand, if the ratio P₂O₅/ZrO₂ is too small, phase separation is less likely to occur.

Al₂O₃ is a component that increases the weather resistance and mechanical strength of the porous glass member. The content of Al₂O₃ is 0 to 10%, preferably 0.1 to 7%, and particularly preferably 1 to 5%. If the content of Al₂O₃ is too large, the melting temperature is likely to increase to decrease meltability.

RO (where R represents at least one selected from among Mg, Ca, Sr, and Ba) is a component that increases the content of ZrO₂ in a silica-rich phase. Therefore, by containing RO in the glass base material, the content of ZrO₂ in the obtained porous glass member increases, so that the alkali resistance can be increased. RO is also a component that increases the weather resistance of the porous glass member. The content of RO (i.e., the total content of MgO, CaO, SrO, and BaO) is 0 to 20%, preferably 1 to 17%, more preferably 3 to 15%, still more preferably 4 to 13%, yet still more preferably 5 to 12%, and particularly preferably 6.5 to 12%. If the content of RO is too large, phase separation is less likely to occur. The content of each of MgO, CaO, SrO, and BaO is preferably 0 to 20%, more preferably 1 to 17%, still more preferably 3 to 15%, yet still more preferably 4 to 13%, even still more preferably 5 to 12%, and particularly preferably 6.5 to 12%. In containing at least two components selected from among MgO, CaO, SrO, and BaO in the glass base material, the total content of them is preferably 0 to 20%, more preferably 1 to 17%, still more preferably 3 to 15%, yet still more preferably 4 to 13%, even still more preferably 5 to 12%, and particularly preferably 6.5 to 12%. Among these RO components, CaO is preferably used in view of its particularly large effect of increasing the alkali resistance of the porous glass member.

The glass base material may contain, in addition to the above components, the following components.

ZnO is a component that increases the content of ZrO₂ in a silica-rich phase. ZnO also has the effect of increasing the weather resistance of the porous glass member. The content of ZnO is preferably 0 to 20%, more preferably 0 to 10%, and particularly preferably 0 to below 3%. If the content of ZnO is too large, phase separation is less likely to occur.

The glass base material may contain TiO₂, La₂O₃, Ta₂O₅, TeO₂, Nb₂O₅, Gd₂O₃, Y₂O₃, Eu₂O₃, Sb₂O₃, SnO₂, Bi₂O₃, and so on, each preferably in a range of 15% or less, more preferably 10% or less, particularly preferably 5% or less, and in a range of 30% or less in total content.

PbO is a substance of environmental concern and, therefore, the glass base material is preferably substantially free of this component. Herein, “substantially free of” means that this component is not deliberately incorporated as a raw material into the glass base material and, objectively, means that the content thereof is less than 0.1%.

Preferred composition examples of the glass base material are described below.

The glass base material preferably contains, in terms of % by mole, 45 to 75% SiO₂, 10 to 30% B₂O₃, 0 to 20% Li₂O, over 0 to 20% Na₂O, over 0 to 20% K₂O, 0 to 20% Li₂O+Na₂O+K₂O, 0.1 to 0.5 Na₂O/B₂O₃, 0.2 to 0.5 (Li₂O+Na₂O+K₂O)/B₂O₃, 0.01 to 1.5% P₂O₅, 2 to 15% ZrO₂, 0.005 to 0.5 P₂O₅/ZrO₂, 0.1 to 7% Al₂O₃, 1 to 17% RO (where R represents at least one selected from among Mg, Ca, Sr, and Ba), 0 to 20% ZnO, 15% or less TiO₂, 15% or less La₂O₃, 15% or less Ta₂O₅, 15% or less TeO₂, 15% or less Nb₂O₅, 15% or less Gd₂O₃, 15% or less Y₂O₃, 15% or less Eu₂O₃, 15% or less Sb₂O₃, 15% or less SnO₂, 15% or less Bi₂O₃, and below 0.1% PbO.

The glass base material preferably contains, in terms of % by mole, 47 to 65% SiO₂, 15 to 25% B₂O₃, 0 to 15% Li₂O, 3 to 15% Na₂O, 0.3 to 5% K₂O, over 0 to 20% Li₂O+Na₂O+K₂O, 0.15 to 0.45 Na₂O/B₂O₃, 0.29 to 0.45 (Li₂O+Na₂O+K₂O)/B₂O₃, 0.02 to 1% P₂O₅, 2.5 to 12% ZrO₂, 0.01 to 0.2 P₂O₅/ZrO₂, 1 to 5% Al₂O₃, 3 to 15% RO (where R represents at least one selected from among Mg, Ca, Sr, and Ba), 0 to 10% ZnO, 10% or less TiO₂, 10% or less La₂O₃, 10% or less Ta₂O₅, 10% or less TeO₂, 10% or less Nb₂O₅, 10% or less Gd₂O₃, 10% or less Y₂O₃, 10% or less Eu₂O₃, 10% or less Sb₂O₃, 10% or less SnO₂, 10% or less Bi₂O₃, and below 0.1% PbO.

The glass base material preferably contains, in terms of % by mole, 50 to 60% SiO₂, 15 to 25% B₂O₃, 0 to 10% Li₂O, 4 to 10% Na₂O, 0.5 to 3% K₂O, 2 to 15% Li₂O+Na₂O+K₂O, 0.2 to 0.4 Na₂O/B₂O₃, 0.31 to 0.42 (Li₂O+Na₂O+K₂O)/B₂O₃, 0.02 to 1% P₂O₅, 2.5 to 12% ZrO₂, 0.01 to 0.2 P₂O₅/ZrO₂, 1 to 5% Al₂O₃, 4 to 13% RO (where R represents at least one selected from among Mg, Ca, Sr, and Ba), 0 to below 3% ZnO, 5% or less TiO₂, 5% or less La₂O₃, 5% or less Ta₂O₅, 5% or less TeO₂, 5% or less Nb₂O₅, 5% or less Gd₂O₃, 5% or less Y₂O₃, 5% or less Eu₂O₃, 5% or less Sb₂O₃, 5% or less SnO₂, 5% or less Bi₂O₃, and below 0.1% PbO.

The glass base material preferably contains, in terms of % by mole, 50 to 60% SiO₂, 15 to 25% B₂O₃, 0 to 10% Li₂O, 4 to 10% Na₂O, 0.5 to 3% K₂O, 4 to 12% Li₂O+Na₂O+K₂O, 0.2 to 0.4 Na₂O/B₂O₃, 0.33 to 0.42 (Li₂O+Na₂O+K₂O)/B₂O₃, 0.02 to 1% P₂O₅, 2.5 to 12% ZrO₂, 0.01 to 0.2 P₂O₅/ZrO₂, 1 to 5% Al₂O₃, 5 to 12% RO (where R represents at least one selected from among Mg, Ca, Sr, and Ba), 0 to below 3% ZnO, 30% or less TiO₂+La₂O₃+Ta₂O₅+TeO₂+Nb₂O₅+Gd₂O₃+Y₂O₃+Eu₂O₃+Sb₂O₃+SnO₂+Bi₂O₃, and below 0.1% PbO.

The glass base material preferably contains, in terms of % by mole, 50 to 60% SiO₂, 15 to 25% B₂O₃, 0 to 10% Li₂O, 4 to 10% Na₂O, 0.5 to 3% K₂O, 5 to 10% Li₂O+Na₂O+K₂O, 0.2 to 0.4 Na₂O/B₂O₃, 0.33 to 0.42 (Li₂O+Na₂O+K₂O)/B₂O₃, 0.02 to 1% P₂O₅, 2.5 to 12% ZrO₂, 0.01 to 0.2 P₂O₅/ZrO₂, 1 to 5% Al₂O₃, 6.5 to 12% RO (where R represents at least one selected from among Mg, Ca, Sr, and Ba), 0 to below 3% ZnO, 30% or less TiO₂+La₂O₃+Ta₂O₅+TeO₂+Nb₂O₅+Gd₂O₃+Y₂O₃+Eu₂O₃+Sb₂O₃+SnO₂+Bi₂O₃, and below 0.1% PbO.

A glass batch formulated to give each of the above glass compositions is melted, for example, at 1300 to 1600° C. for 4 to 12 hours. Subsequently, the molten glass is formed into shape and then annealed, for example, at 400 to 600° C. for 10 minutes to 10 hours, thus obtaining a glass base material. The shape of the obtained glass base material is not particularly limited, but is preferably a platy shape having a rectangular or circular planar figure. In order to make the obtained glass base material into a desired shape, the glass base material may be subjected to processing, such as cutting or polishing.

The obtained glass base material preferably has an aspect ratio of 2 to 1000 and particularly preferably 5 to 500. If the aspect ratio is too small, this creates a large difference in etching rate between the surface and inside of the glass base material in the process for removing (etching) a boron oxide-rich phase with an acid, so that stress is likely to be produced inside of the porous glass member and the porous glass member is therefore likely to crack. On the other hand, if the aspect ratio is too large, the glass base material is difficult to handle.

The base area and thickness of the obtained glass base material may be appropriately adjusted to give the above aspect ratio. For example, the base area is preferably 1 to 1000 mm² and particularly preferably 5 to 500 mm² and the thickness is preferably 0.1 to 1 mm and particularly preferably 0.2 to 0.5 mm.

Next, the obtained glass base material is subjected to thermal treatment to separate (spinodally separate) it into two phases: a silica-rich phase and a boron oxide-rich phase. The temperature for the thermal treatment is preferably 500 to 800° C. and particularly preferably 600 to 750° C. If the temperature for the thermal treatment is too high, the glass base material softens and is therefore less likely to obtain a desired shape. On the other hand, if the temperature for the thermal treatment is too low, the glass base material is less likely to undergo phase separation. The time for the thermal treatment is preferably one minute or more, more preferably ten minutes or more, and particularly preferably 30 minutes or more. If the time for the thermal treatment is too short, the glass base material is less likely to undergo phase separation. The upper limit of the time for the thermal treatment is not particularly limited. However, even if the glass base material is thermally treated for a long time, phase separation does not progress beyond a certain level.

Therefore, the time for the thermal treatment is actually not more than 180 hours.

Next, the glass base material separated into two phases is immersed into an acid to remove the boron oxide-rich phase, thus obtaining a porous glass member. The acid that can be used is hydrochloric acid or nitric acid. These acids may be used in mixture. The concentration of the acid is preferably 0.1 to 5N and particularly preferably 0.5 to 3 N. The time for immersion in the acid is preferably an hour or more, more preferably 10 hours or more, and particularly preferably 20 hours or more. If the time for immersion is too short, etching is insufficient, which makes it difficult to obtain a porous glass member having desired interconnected pores. The upper limit of the time for immersion is not particularly limited, but it is actually not more than 100 hours. The temperature during immersion is preferably 20° C. or higher, more preferably 25° C. or higher, and particularly preferably 30° C. or higher. If the temperature during immersion is too low, etching is insufficient, which makes it difficult to obtain a porous glass member having desired interconnected pores. The upper limit of the temperature during immersion is not particularly limited, but it is actually not higher than 95° C.

In the process for separating the glass base material into phases, a silica-containing layer (a layer containing silica in a content of approximately 80% by mole or more) may be formed in the uppermost portion of the surface of the glass base material. The silica-containing layer is difficult to remove with an acid. Therefore, if a silica-containing layer has been formed, the glass base material separated into phases is cut and polished to remove the silica-containing layer and then immersed into an acid. Thus, the boron oxide-rich phase can be easily removed. Alternatively, in order to remove the silica-containing layer, the glass base material separated into phases may be immersed into hydrofluoric acid for a short time.

Furthermore, it is preferred to remove residual ZrO₂ colloid and SiO₂ colloid in the pores of the obtained porous glass.

ZrO₂ colloid can be removed, for example, by immersing the glass base material into sulfuric acid. The concentration of sulfuric acid is preferably 0.1 to 5 N and particularly preferably 1 to 5 N. The time for immersion in sulfuric acid is preferably an hour or more and particularly preferably 10 hours or more. If the time for immersion is too short, ZrO₂ colloid is less likely to be removed. The upper limit of the time for immersion is not particularly limited, but it is actually not more than 100 hours. The temperature during immersion is preferably 20° C. or higher, more preferably 25° C. or higher, and particularly preferably 30° C. or higher. If the temperature during immersion is too low, ZrO₂ colloid is less likely to be removed. The upper limit of the temperature during immersion is not particularly limited, but it is actually not higher than 95° C.

SiO₂ colloid can be removed, for example, by immersing the glass base material into an aqueous alkaline solution. Examples of the aqueous alkaline solution that can be used include sodium hydroxide aqueous solution and potassium hydroxide aqueous solution. These aqueous alkaline solutions may be used in mixture. The time for immersion in the aqueous alkaline solution is preferably 10 minutes or more and particularly preferably 30 minutes or more. If the time for immersion is too short, SiO₂ colloid is less likely to be removed. The upper limit of the time for immersion is not particularly limited, but it is actually not more than 100 hours. The temperature during immersion is preferably 15° C. or higher and particularly preferably 20° C. or higher. If the temperature during immersion is too low, SiO₂ colloid is less likely to be removed. The upper limit of the temperature during immersion is not particularly limited, but it is actually not higher than 95° C.

As necessary, the obtained porous glass member may be subjected to washing treatment with ion-exchange water or the like. In this case, in order for the porous glass member to be prevented from cracking when dried, the member subjected to the washing treatment is preferably immersed into a solvent having a small surface tension, such as ethanol, methanol or 2-propanol, to substitute water attached to the surface of the member with the solvent.

The obtained porous glass member preferably contains, in terms of % by mass, 50 to 99% (more preferably 54 to 90%) SiO₂, 0 to 15% (more preferably 0.01 to 10%) Na₂O, 0 to 10% (more preferably 0 to 5%) K₂O, over 0 to 10% (more preferably 0.05 to 8%) P₂O₅, over 0 to 30% (more preferably 4 to 25%) ZrO₂, over 0 to 20% (more preferably 1 to 15%) Al₂O₃, and 0 to 20% (more preferably 0 to 15%) RO (where R represents at least one selected from among Mg, Ca, Sr, and Ba). When, as just described, the porous glass member contains respective predetermined amounts of SiO₂ and ZrO₂, the porous glass member can achieve excellent alkali resistance.

The median value of the pore distribution of the porous glass member is preferably 1 m or less, more preferably 200 nm or less, still more preferably 150 nm or less, yet still more preferably 120 nm or less, even more preferably 100 nm or less, even still more preferably 90 nm or less, even yet still more preferably 80 nm or less, and particularly preferably 70 nm or less. The lower limit of the median value of the pore distribution is not particularly limited, but it is actually preferably not less than 1 nm, more preferably not less than 2 nm, and still more preferably not less than 4 nm. Examples of the pore shape include a continuum of spherical pores, a continuum of approximately ellipsoidal pores, and a tubular shape.

The aspect ratio, base area, thickness, and other dimensions of the porous glass member are the same as those of the glass base material. Specifically, the aspect ratio of the porous glass member is preferably 2 to 1000 and particularly preferably 5 to 500. The base area of the porous glass member is preferably 1 to 1000 mm² and particularly preferably 5 to 500 mm² and the thickness thereof is preferably 0.1 to 1 mm and particularly preferably 0.2 to 0.5 mm.

### EXAMPLES

Hereinafter, the present invention will be described with reference to examples, but is not limited to these examples.

Tables 1 to 3 show examples (Sample Nos. 1 to 20) of the present invention and comparative examples (Sample Nos. 21 and 22).

TABLE 1

| | | 1 | 2 | 3 | 4 | 5 | 6 | 7 | 8 | 9 |
|---|---|---|---|---|---|---|---|---|---|---|
| Glass Base | SiO₂ | 56.85 | 57.8 | 56.8 | 57.75 | 56.75 | 54.75 | 59.55 | 59.02 | 58.5 |
| Material | Al₂O₃ | 2 | 2 | 2 | 2 | 2 | 2 | 2 | 2 | 2 |
| (% by mole) | B₂O₂ | 20 | 20 | 20 | 20 | 20 | 20 | 20 | 20 | 20 |
| | Na₂O | 7 | 7 | 7 | 7 | 7 | 7 | 7.4 | 7.4 | 7.4 |
| | K₂O | | | | | | | | | |
| | CaO | 9 | 9 | 9 | 9 | 9 | 9 | 8 | 8.5 | 9 |
| | ZrO₂ | 5 | 4 | 5 | 4 | 5 | 7 | 3 | 3 | 3 |
| | P₂O₅ | 0.15 | 0.2 | 0.2 | 0.25 | 0.25 | 0.25 | 0.05 | 0.08 | 0.1 |
| | TiO₂ | | | | | | | | | |
| | Li₂O + Na₂O + K₂O | 7.00 | 7.00 | 7.00 | 7.00 | 7.00 | 7.00 | 7.40 | 7.40 | 7.40 |
| | (Li₂O + Na₂O + K₂O)/B₂O₃ | 0.35 | 0.35 | 0.35 | 0.35 | 0.35 | 0.35 | 0.37 | 0.37 | 0.37 |
| | Na₂O/B₂O₃ | 0.35 | 0.35 | 0.35 | 0.35 | 0.35 | 0.35 | 0.37 | 0.37 | 0.37 |
| | P₂O₅/ZrO₂ | 0.03 | 0.05 | 0.04 | 0.06 | 0.05 | 0.04 | 0.02 | 0.03 | 0.03 |
| Porous Glass | SiO₂ | 67.3 | 76.5 | 60.1 | 82.2 | 65.8 | 54.5 | 86.0 | 81.6 | 86.2 |
| Member | Al₂O₃ | 4.2 | 10.4 | 4.1 | 1.3 | 4.3 | 3.9 | 3.3 | 3.0 | 3.4 |
| (% by mass) | Na₂O | 5.0 | 1.3 | 6.9 | 5.2 | 6.2 | 7.9 | 4.0 | 6.8 | 3.4 |
| | K₂O | | | | | | | | | |
| | CaO | 9.7 | 0.1 | 8.3 | | 8.9 | 7.2 | 0.1 | | |
| | ZrO₂ | 12.6 | 8.1 | 16.4 | 7.4 | 12.9 | 21.2 | 6.4 | 7.6 | 6.4 |
| | P₂O₅ | 1.2 | 3.6 | 4.2 | 3.9 | 1.9 | 5.3 | 0.2 | 1.0 | 0.6 |
| | TiO₂ | | | | | | | | | |
| | Alkali resistance | good | good | good | good | good | good | good | good | good |

TABLE 2

| | | 10 | 11 | 12 | 13 | 14 | 15 | 16 | 17 | 18 |
|---|---|---|---|---|---|---|---|---|---|---|
| Glass Base | SiO₂ | 57.98 | 58.02 | 58.02 | 56.95 | 53.9 | 53.4 | 58.16 | 54.4 | 53.8 |
| Material | Al₂O₃ | 2 | 2 | 2 | 3 | 3 | 3 | 1.7 | 2 | 2 |
| (% by mole) | B₂O₂ | 20 | 20 | 20 | 20 | 19.7 | 19.7 | 17 | 16 | 16 |
| | Na₂O | 7.4 | 6.9 | 6.2 | 5.5 | 5.7 | 5.7 | 5.7 | 5.3 | 5 |
| | K₂O | | 0.5 | 1.2 | 1.5 | 1.6 | 1.6 | 0.8 | 1 | 1.3 |
| | CaO | 9.5 | 9.5 | 9.5 | 9 | 11 | 11 | 8.8 | 10 | 10 |
| | ZrO₂ | 3 | 3 | 3 | 4 | 4 | 4 | 6 | 10 | 10 |
| | P₂O₅ | 0.12 | 0.08 | 0.08 | 0.05 | 0.1 | 0.1 | 0.14 | 0.3 | 0.4 |
| | TiO₂ | | | | | 1 | 1.5 | 1.7 | 1 | 1.5 |
| | Li₂O + Na₂O + K₂O | 7.40 | 7.40 | 7.40 | 7.00 | 7.30 | 7.30 | 6.50 | 6.30 | 6.30 |
| | (Li₂O + Na₂O + K₂O)/B₂O₃ | 0.37 | 0.37 | 0.37 | 0.35 | 0.37 | 0.37 | 0.38 | 0.39 | 0.39 |
| | Na₂O/B₂O₃ | 0.37 | 0.35 | 0.31 | 0.28 | 0.29 | 0.29 | 0.34 | 0.33 | 0.31 |
| | P₂O₅/ZrO₂ | 0.04 | 0.03 | 0.03 | 0.01 | 0.03 | 0.03 | 0.02 | 0.03 | 0.04 |
| Porous Glass | SiO₂ | 83.7 | 83.9 | 80.8 | 72.5 | 82.6 | 78.5 | 83.3 | 68.4 | 79.3 |
| Member | Al₂O₃ | 4.0 | 3.9 | 4.1 | 5.7 | 3.3 | 4.4 | 2.9 | 1.9 | 3.4 |
| (% by mass) | Na₂O | 5.6 | 5.8 | 5.7 | 7.4 | 5.6 | 8.6 | 0.1 | | 0.1 |
| | K₂O | | | | 0.8 | | | | | |
| | CaO | | | 0.1 | 4.2 | | | 0.4 | 0.1 | 0.5 |
| | ZrO₂ | 6.6 | 6.1 | 8.0 | 9.2 | 7.8 | 7.5 | 10.6 | 22.4 | 14.2 |
| | P₂O₅ | 0.1 | 0.3 | 1.3 | 0.2 | 0.2 | 0.4 | 1.7 | 6.9 | 1.9 |
| | TiO₂ | | | | | 0.5 | 0.6 | 1.0 | 0.3 | 0.6 |
| | Alkali resistance | good | good | good | good | good | good | good | good | good |

TABLE 3

| | | 19 | 20 | 21 | 22 |
|---|---|---|---|---|---|
| Glass Base | SiO₂ | 57.86 | 57.98 | 59 | 65.16 |
| Material | Al₂O₃ | 1.5 | 1.7 | 2 | |
| (% by mole) | B₂O₃ | 15 | 17 | 20 | 24.93 |
| | Na₂O | 5 | 5.7 | 7 | 9.91 |
| | K₂O | 0.7 | 0.8 | | |
| | CaO | 9.5 | 9 | 9 | |
| | ZrO₂ | 10 | 6 | 3 | |
| | P₂O₅ | 0.24 | 0.12 | | |
| | TiO2 | 0.2 | 1.7 | | |
| | Li₂O + Na₂O + | 5.70 | 6.50 | 7.00 | 9.91 |
| | K₂O | | | | |
| | (Li₂O + Na₂O + | 0.38 | 0.38 | 0.35 | 0.40 |
| | K₂O)/B₂O₃ | | | | |
| | Na₂O/B₂O₃ | 0.33 | 0.34 | 0.35 | 0.40 |
| | P₂O₅/ZrO₂ | 0.02 | 0.02 | 0.00 | - |
| Porous Glass | SiO₂ | 74.6 | 86.4 | 90.3 | 99.9 |
| Member | Al₂O₃ | 2.6 | 2.8 | 2.8 | |
| (% by mass) | Na₂O | 0.4 | 0.1 | 3.3 | 0.1 |
| | K₂O | 0.2 | | | |
| | CaO | 0.7 | 0.2 | 0.1 | |
| | ZrO₂ | 16.8 | 8.7 | 3.5 | |
| | P₂O₅ | 4.6 | 1.0 | | |
| | TiO₂ | 0.1 | 0.8 | | |
| | Alkali resistance | good | good | poor | poor |

Raw materials formulated to give each of the compositions in the tables were put into a platinum crucible and then melted therein at 1400° C. to 1500° C. for four hours. During melting of the raw materials, they were stirred using a platinum stirrer to homogenize them. Next, the molten glass was poured onto a metallic sheet to form it into a platy shape and then annealed at 580° C. to 540° C. for 30 minutes, thus obtaining a glass base material.

The obtained glass base material was cut and polished to a size of 5 mm×5 mm×0.5 mm. Thereafter, the glass base material was thermally treated in an electric furnace at 500° C. to 800° C. for 10 minutes to 24 hours to separate it into phases. The glass base material separated into phases was immersed into 1 N nitric acid (at 95° C.) for 48 to 96 hours, then washed with ion-exchange water, subsequently immersed into 3 N sulfuric acid (at 95° C.) for 48 to 96 hours, then washed with ion-exchange water, subsequently immersed into 0.5 N sodium hydroxide aqueous solution (at room temperature) for 3 hours to 5 hours, then washed with ion-exchange water, then immersed into 2-propanol, and then picked up from the 2-propanol. In this manner, a porous glass member was obtained.

When the cross sections of the obtained porous glass members were observed with an FE-SEM (SU-8220 manufactured by Hitachi, Ltd.), all the glasses had a skeleton structure based on spinodal phase separation.

Next, the porous glass members were analyzed with EDX (EX-370X-Max^{N}150 manufactured by Horiba, Ltd.) to measure the respective compositions of the porous glass members. The analysis was conducted on three points of a central portion of the cross section of each porous glass member and the average of the three measured values was adopted.

Furthermore, each porous glass member was evaluated in terms of alkali resistance in the following manner. The porous glass member was immersed into 0.5 N sodium hydroxide aqueous solution held at 80° C. for 20 minutes. With respect to the amount of weight reduction per specific surface area between before and after the immersion, the members having an amount of weight reduction of less than 3 m²/g were evaluated as “good” and the members having an amount of weight reduction of 3 m²/g or more were evaluated as “poor”. The specific surface area was measured with QUADRASORB SI manufactured by Quantachrome Instruments.

As for Sample Nos. 1 to 20 that are examples of the present invention, the ZrO₂ content in the porous glass member was as large as 6.1 to 22.4% by mass and, therefore, they had excellent alkali resistance. In contrast, as for Sample Nos. 21 and 22 that are comparative examples, the ZrO₂ content was as small as 3.5% by mass or less and, therefore, they had poor alkali resistance.

### INDUSTRIAL APPLICABILITY

The porous glass member produced by the method according to the present invention is suitable for various applications, including a separation membrane, a diffuser tube, an electrode material, and a catalyst support.

1. A method for producing a porous glass member, the method comprising the steps of: subjecting a glass base material containing, in terms of % by mole, 40 to 80% SiO₂, over 0 to 40% B₂O₃, 0 to 20% Li₂O, 0 to 20% Na₂O, 0 to 20% K₂O, over 0 to 2% P₂O₅, over 0 to 20% ZrO₂, 0 to 10% Al₂O₃, and 0 to 20% RO (where R represents at least one selected from among Mg, Ca, Sr, and Ba) to thermal treatment to separate the glass base material into two phases; and removing one of the two phases with an acid.

2. The method for producing a porous glass member according to claim 1, wherein the glass base material has an aspect ratio of 2 to 1000.

3. A glass base material for a porous glass member, the glass base material containing, in terms of % by mole, 40 to 80% SiO₂, over 0 to 40% B₂O₃, 0 to 20% Li₂O, 0 to 20% Na₂O, 0 to 20% K₂O, over 0 to 2% P₂O₅, over 0 to 20% ZrO₂, 0 to 10% Al₂O₃, and 0 to 20% RO (where R represents at least one selected from among Mg, Ca, Sr, and Ba).

4. A porous glass member containing, in terms of % by mass, 50 to 99% SiO₂, 0 to 15% Na₂O, 0 to 10% K₂O, over 0 to 10% P₂O₅, over 0 to 30% ZrO₂, over 0 to 20% Al₂O₃, and 0 to 20% RO (where R represents at least one selected from among Mg, Ca, Sr, and Ba).
